(19) United States
(12) Patent Application Publication
(10) Pub. No.: US 2025/0376557 A1
(43) Pub. Date: Dec. 11, 2025

(54) NITROGEN ASSISTED POLYESTER COVALENT ADAPTABLE NETWORKS

(71) Applicant: Alliance for Sustainable Energy, LLC, Golden, CO (US)

(72) Inventors: Nicholas A. RORRER, Golden, CO (US); Erik Glenn ROGNERUD, Parker, CO (US)

(21) Appl. No.: 19/083,227

(22) Filed: Mar. 18, 2025

Related U.S. Application Data
(60) Provisional application No. 63/566,734, filed on Mar. 18, 2024.

(51) Int. Cl. C08G 59/68; C08G 59/42

(52) U.S. Cl. CPC C08G 59/686; C08G 59/4238

(57) ABSTRACT

Disclosed herein are nitrogen assisted polyester covalent adaptable networks where the use of a di-glycidyl (or higher or lower functionality) ester with di-amines (or higher or lower functionality) will generate a system that is capable of curing quickly and at low temperatures and is capable of chemical depolymerization and at accelerated rates than epoxy-anhydride systems; and is capable of transesterification and at accelerated rates than epoxy-anhydride system.

### CROSS-REFERENCE TO RELATED APPLICATIONS

This application claims priority under 35 U.S.C. § 119 to U.S. provisional patent application No. 63/566,734 filed on 18 Mar. 2024, the contents of which are hereby incorporated in their entirety.

### CONTRACTUAL ORIGIN

The United States Government has rights in this invention under Contract No. DE-AC36-08GO28308 between the United States Department of Energy and Alliance for Sustainable Energy, LLC, the Manager and Operator of the National Renewable Energy Laboratory.

### BACKGROUND

There is a need for improving recycling of polyesters. Reducing the amount of plastic waste is important to the environment. Increasing the recyclability of plastics containing polyester bonds would greatly reduce the amount of plastic waste. The monomer components and the decomposition products from recycled plastic could be valorized to create compounds of interest.

Epoxy-amine thermosetting materials are a robust class of polymers that are easily formulated (many available monomer options), easily processed (liquid monomers that polymerize quickly and with low energy inputs), and exhibit excellent thermomechanical profiles (thermal stability, flexibility, strength, etc.). Unfortunately, these materials are comprised of recalcitrant ether and amide bonds that complicate recycling processes, resulting in most of these materials being landfilled or incinerated at the end of life. Epoxy-anhydride systems, while necessitating larger energy inputs for polymerization, have been established that leverage the more labile ester bonds (intrinsic to the anhydride hardener) for simplified repurposing or recycling at the end of life.

### SUMMARY

In an aspect, disclosed herein are methods for advancing circularity into thermosetting resin systems comprising the use of a multi-epoxide (di-epoxide or greater) monomer unit with internal hydroxy functionality (conventionally sorbitol polyglycidyl ether—SPGE). In an embodiment, the method of claim 1 further comprises the use of an anhydride hardener (conventionally methyl hexahydropthalic anhydride—MHHPA) and the step of combining with epoxy and nitrogen-based accelerator (conventionally 2-ethyl-4-methyl imidazole—24EMI) to facility the cure (called crosslinking, polymerization, gelation, reaction, etc) into a rigid 3-dimensional network. In an embodiment, the network can rearrange with itself to allow re-processing and with methanol to allow depolymerization. In an embodiment, the reactions are catalyzed and/or accelerated by a nitrogen-based unit. In an embodiment, the reactions constitute the cure (or polymerization) as well as the network rearranging with itself (internal transesterification) and the rearrangement with methanol to allow depolymerization (methanolysis).

In an embodiment, the method uses different nitrogen-based accelerators at different loadings to accelerate both cure and transesterification.

Other objects, advantages, and novel features of the present invention will become apparent from the following detailed description of the invention when considered in conjunction with the accompanying drawings.

### BRIEF DESCRIPTION OF THE DRAWINGS

FIG. 1 depicts the state of the industry (top) and the methods disclosed herein (bottom) to advance circularity into thermosetting (traditionally non-recyclable) resin systems.

FIG. 2 depicts representative structures and example monomers for each class of materials disclosed herein. Accelerators, or alternatively referred to herein as catalysts, as depicted in FIG. 2 include, but are not limited to, N-methyl piperidine (Mpip); triethylamine (TEA); imidazole (Imid): 1-methyl imidazole (1MI): pyridine (Pyr): dimethyl aniline (DMAn): tributylamine (TBA): tripropylamine (TPA): 2-ethyl-4-methyl imidazole (24EMI): 1,8-diazabicyclo[5.4.0]undec-7-ene (DBU): 4-dimethylaminopyridine (DMAP); and N,N,N,N-tetramethyl-1,4-phenylenediamine (TMPDA).

FIG. 3 depicts a representative PolyEster Covalent Adaptable Network (PECAN) thermoset network disclosed herein. In an embodiment, a composition of 0.3 mol equivalents of SPGE, 0.7 mol equivalents of butanediol diglycidyl ether (BDODGE), and 1.0 mol equivalents of MHHPA is used.

FIG. 4 depicts isothermal heat flow experiments of PECAN formulations with different nitrogen-based-catalyst. The heat flow of the resin sample is measured via differential scanning calorimetry (DSC) to evaluate the exotherm (signal in the positive direction) of the reaction. FIG. 4 depicts an isothermal dwell of 80° C. for 500 minutes showing the effect of increasing nitrogen catalyst loading will influence the cure response.

FIGS. 5A, 5B, and 5C depict the effect of catalyst on the curing procedure. FIG. 5(A) depicts an overlay of DSC thermogram dynamic cures (heated from 25° C. to 200° C. at 2° C./min) analyze the heat of the reaction as a function of temperature for a variety of different nitrogen-based catalysts (0.02 mol equivalent). The thermograms are color coded to catalysts (accelerators) depicted in FIG. 2. The differences in the shapes of the exotherm show how the heat of the reaction and therefore the polymerization can be tuned with the choice in nitrogen-based catalyst. FIB. 5B depicts a graphical representation of the onset temperature, or temperature when the exotherm begins to aggressively ramp, from the dynamic curing experiments shown in (FIG. 5A). FIG. 5C depicts a graphical display of the cure progression for each PECAN system with different catalysts denoting the gel point and the cure completion at an industrially relevant temperature of 80° C. Gel point is noted as the time at which the liquid mixture become a solid quantified from rheological experiments (1% strain, 10 rad/s, 80° C.) as the point when the storage modulus and the loss modulus intersect. End set temperatures are noted as the time at which the exotherm (akin to experiments depicted in FIG. 5A) begins to rapidly decay denoted the nominal completion of the reaction.

FIG. 6 depicts a proposed mechanism for the nitrogen-mediated internal reaction within a PECAN thermoset.

FIGS. 7A and 7B depict (A) Stress relaxation experiments on a PECAN formulation at temperatures from 185° C. to 215° C. within a Dynamic Mechanical Analyzer (DMA).

FIG. 8 depicts percent deconstruction via methanolysis or transesterification with methanol for PECAN formulations cured with various catalysts as disclosed herein, see FIG. 2.

FIG. 9 depicts the state of the industry for thermosetting resins (top), current advances in sustainable thermosets (middle) and the research/innovation we have done (bottom) in this space. The PECAN system utilizes anhydrides to install recyclable ester linkages into the thermoset network allowing for chemical recyclability (usually methanolysis) and reprocessing (called internal transesterification). Unfortunately, the anhydride requires high temperatures (>80° C.) to react which limits the applicability of this material and complicates processing. Conversely, the NAPCAN technology utilizes ester linkages inherent to the epoxy (called a glycidyl ester, HHPADGE is shown here which is the only commercially available glycidyl ester), and reacts with amines (that don't require high temperatures). Serendipitously, the NAPCAN technology also recycles and reprocesses faster than the PECAN analog which we owe to the presence of stoichiometric nitrogen (catalytic action), hydroxyl, and esters (both needed for reprocessing.

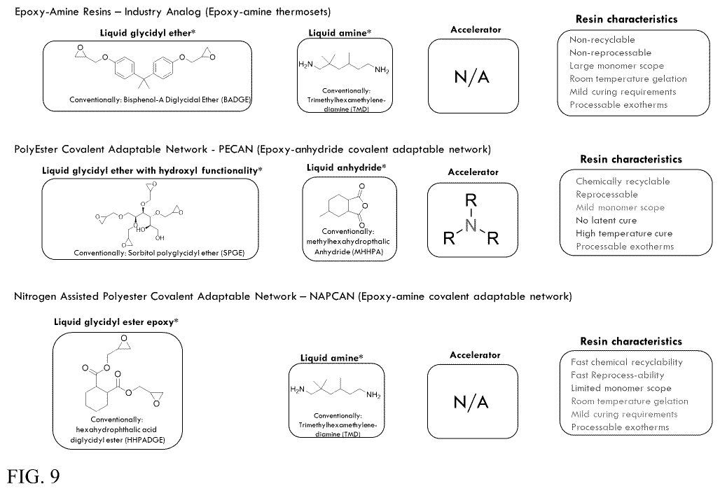

FIG. 10 depicts structures and example monomers are given above for each class of materials. Monomers are combined in any addition order and in varying stoichiometry (amine/anhydride to epoxide). Monomers (generally liquid, but can be solid) are mechanically mixed with and/or without solvent to generate a homogenous mixture of monomers. The mixture can then be cast into desired shape or into desired reinforcing media (carbon fiber, glass fiber, basalt fiber, Kevlar, flax fibers, bio-fibers, fillers, etc.) where they will cure (or gel, or polymerize, or solidify) under a stimulus of time, temperature, Infrared laser, or UV-light. The final solid product is then deployed or evaluated for performance. FIG. 10 depicts a method that uses 81.1 wt % BADGE that was hand mixed with 18.9 wt % TMD and then speed-mixed at 1000 RPM for 10 seconds and 2000 RPM for 2 minutes in a speedmixer to make the Industry Analog resin system. The combined liquid mixture was then cast into necessary dimensions (cubes, rectangles, dogbones, etc.) for further analysis. The PECAN 35 resin system was made by combing 37.8 wt % SPGE, 11.4 wt % BDODGE, 50.8 wt % MHHPA, and finally 1 wt % (of total mixture) of 1-methyl imidazole (not pictured). The NAPCAN 35 formulation was made by combining 77.3 wt % HHPADGE, 16.2 wt % IPDA, and 6.5 wt % TMD. These ratios of monomers are not meant to be exclusive to this technology, but were specifically formulated to elicit materials with similar and competitive glass transition temperatures (Tg) of about 130° C. This Tg was chosen as it is expected to be suitable for applications up to 100° C. before softening, particularly in the transportation industry. Since the materials are similar glass transition temperatures, their properties can be compared more consistently.

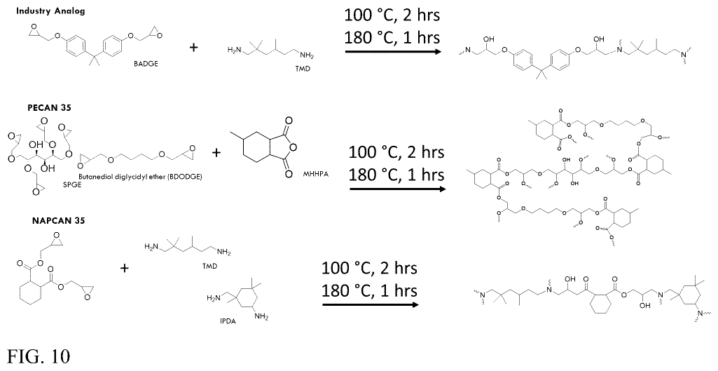

FIG. 11 depicts thermoset conversion at various temperatures (40-140° C.) that were extrapolated from differential scanning calorimetry experiments that monitored the heat (exotherm) at various temperatures, times, and heating rates. The NAPCAN 35 system cures much faster than the PECAN system and even faster than the industry analog system at all modeled temperatures.

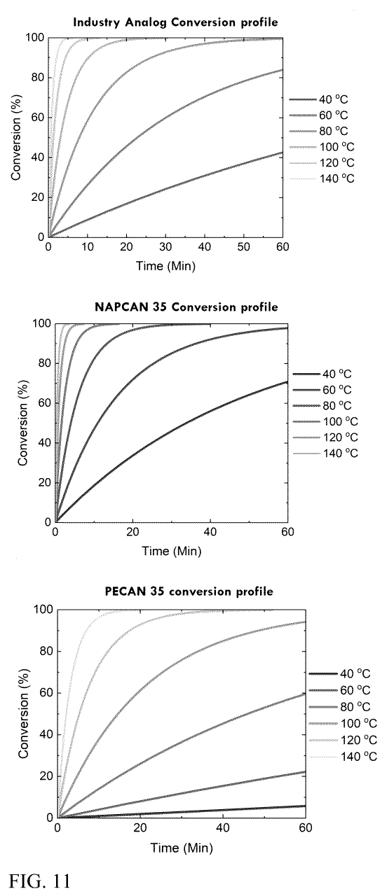

FIGS. 12A and 12B depict data from two experiments. The first experiment (FIG. 12A) evaluates the Tg on a NAPCAN system with an amine crosslinker blend of isophorone diamine (IPDA) and putrescine. The polymer uncured mixture is cured (or polymerized) at 100° C. for 10 minutes and then post-cured at 200° C. for 5 minutes. Shown on the figure are the Tgs of 6 formulation with all IPDA (left) and half IPDA/half putrescine amine (right) after the initial 10 minute cure (purple) and after the postcure (teal). In addition to the evaluation of Tg, the gelation was also qualitively assessed and documenting showing that the polymer will solidify in about 1 minute at 100° C. (right) with half putrescine and IPDA wherein it will take greater than 10 minutes to solidify with a formulation of just IPDA (left). The point of this experiment and data is to illustrate the role that amine identity plays in the polymerization process. Such that increasing putrescine, which is a very reactive amine compared to IPDA, can accelerate the gelation. The Tg's before and after a post-cure illuminate whether the polymer is fully cured under the conditions prescribed. Should the Tg of the initial cure be less than the post-cure, then the polymer was not fully cured or polymerized. With all formulations described in (A), none of them are fully cured after the initial cure showing that amine identity does not facilitate a faster polymerization within this system. Akin to the work presented on Slide 4, the use of an amine catalyst is used to modify the cure completion as presented in (FIG. 12B). Addition of the accelerator (2,4,6-Tris-(dimethylaminomethyl)phenol) at loadings of 5% or more in excess will prompt full polymerization, as evident in the decrease in Tg after the postcure. This again shows the ability of nitrogen containing precursors to modify the cure of a polyester thermosetting matrix.

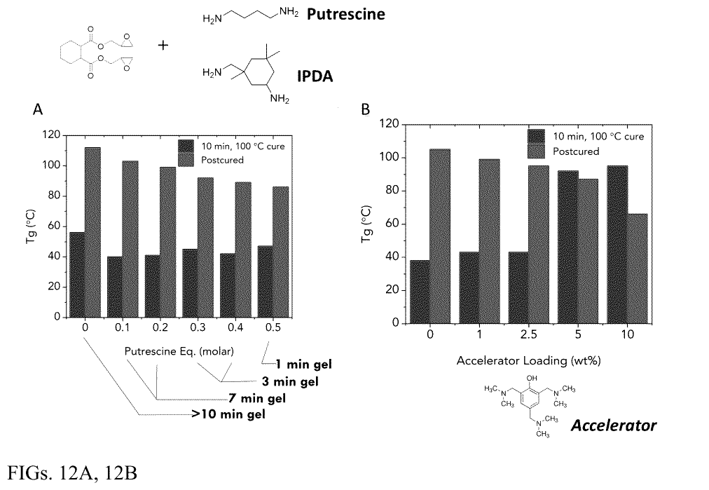

FIGS. 13A, 13B, 13C depict stress relaxation experiments that probe the covalent adaptable nature of PECAN 35 (FIG. 13A) and NAPCAN 35 (FIG. 13B). Specifically, cured (and post-cured) resin rectangles and loaded onto the dynamic mechanical analyzer in single cantilever geometry. The instrument heats the samples to desired temperatures (175-205° C.) and then a slight bend (0.25% strain) is applied to the thermosets and the force is measured against time. Overtime, the bonds in the thermoset architecture will rearrange as exchange bonds (transesterification), effectively reducing the stress on the polymer and reducing the force required to keep it bent. At higher temperatures, this phenomenon becomes faster prompting quicker stress relaxation as shown. As depicted in FIG. 13C, NAPCAN 35 relaxes stress much faster (up to an order of magnitude) than the PECAN system. This is also quantified by calculating the activation energy for the bond exchange and the PECAN has a >2× higher barrier for activation than the NAPCAN system. Without being limited by theory, this behavior is hypothesized to be due to the stoichiometric quantities of hydroxyl and esters as well as the stoichiometric quantities of nitrogen that can catalyze the transesterification process.

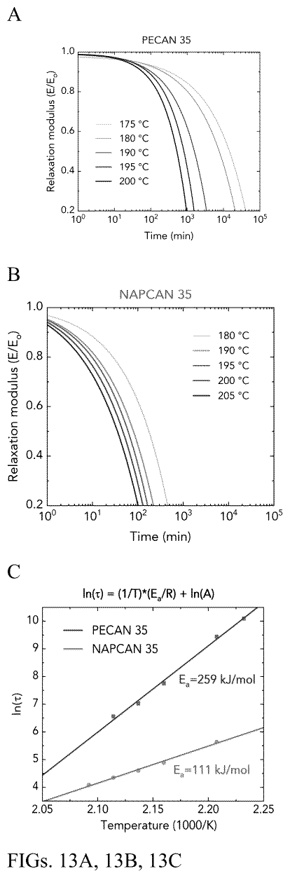

FIG. 14 depicts that transesterification can also leverage depolymerization of the materials. Specifically the reaction of the ester in the PECAN and NAPCAN backbone can react with external methanol to yield small molecule methyl esters and polyols. To demonstrate this, 1 cm³ cubes of both resin systems were subjected to methanol at 200° C. over the course of 6 hours and the mass loss of systems were monitored every hour. NAPCAN 35 shows significantly accelerated deconstruction when compared to the PECAN analog.

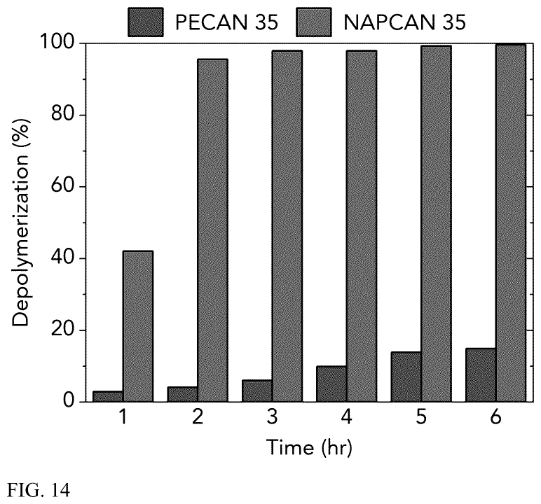

### DETAILED DESCRIPTION

Disclosed herein are methods and compositions of matter that combine the reactivity of amine hardeners with the recyclability of ester bonds through the incorporation of an industrially available glycidyl ester epoxy, hexahydrophthalic acid diglycidyl ester (HHPADGE). In an embodiment, disclosed herein are methods of formulating HHPADGE with industrially relevant amines (isophorone diamine—IDPA and Trimethylhexamethylenediamine—TMD) to generate a polymer of practical thermal stability (Tg of about 130° C.). We compare the processing, the material properties, and the end-of-life options of this novel material with a similarly formulated epoxy-amine (referred to herein as Industry Analog) and an epoxy-anhydride system (referred to herein as polyester covalent adaptable network—PECAN).

Unexpectedly, it was discovered that glycidyl ester-epoxy system polymerizes 33% faster (at 80° C.) than even the Industry Analog and will reprocess or recycle >10× faster than the PECAN counterpart while maintaining material properties similar to both systems. Due to the stoichiometric quantities of amide (nitrogen constituent), ester, and hydroxyl units within this system that contribute to the attributes listed above, this system is referred to herein as Nitrogen Assisted Polyester Covalent Adaptable Network (NAPCAN).

Disclosed herein are methods of making NAPCAN compositions and NAPCAN compositions of matter. The NAPCAN compositions and uses thereof that are disclosed herein provide greater efficiency and sustainability to thermosetting applications, particularly composite applications within the transportation industry that necessitate large volumes of high performing materials.

The incorporation of amines into polyester thermoset compounds results in three benefits: (1) curing at reasonable temperatures (80-120° C.) and (2) enhanced internal transesterification (reaction with a backbone [intrinsic to the polymer chain]ester and a backbone alcohol (conventionally a hydroxyl) and (3) enhanced external transesterification (reaction with a backbone ester and an external alcohol (conventionally methanol). As the lack of latent cure may hinder the ability for the PECAN resin to be implemented in large composite applications this technology overcomes that issue while affording an additional benefit. Applicants have unexpectedly discovered that increasing the nitrogen content (both in concentration and composition or structure) in our formulations of polyester compounds further increases the recyclability of polyester containing plastics.

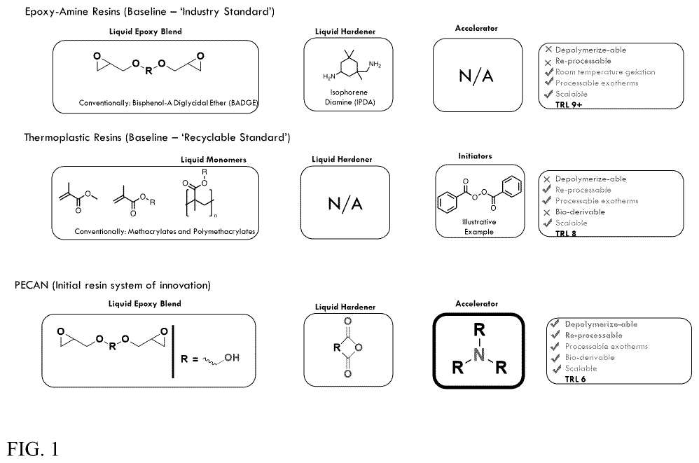

FIG. 1 depicts the state of the industry (top) and the research/innovation we have done (bottom) to advance circularity into thermosetting (traditionally non-recyclable) resin systems. This work initially utilized a multi-epoxide (di-epoxide or greater pictured) monomer unit with internal hydroxy functionality (conventionally sorbitol polyglycidyl ether—SPGE). An anhydride hardener (conventionally methyl hexahydropthalic anhydride—MHHPA) is combined with epoxy and nitrogen-based accelerator (conventionally 2-ethyl-4-methyl imidazole—24EMI) to facilitate the cure (called crosslinking, polymerization, gelation, reaction, etc) into a rigid 3-dimensional network. Through transesterification, this network can rearrange with itself to allow re-processing and with methanol to allow depolymerization. All of which are also catalyzed and/or accelerated by the nitrogen-based unit, both in concentration and composition or structure. The use of different nitrogen-based accelerators at different concentrations for this system to accelerate both cure and transesterification are to be captured. Additionally, a new resin system utilizes multifunctional (di-functional is pictured) epoxies connected to ester groups that can mix and cure with a multifunctional amine (di-functional is

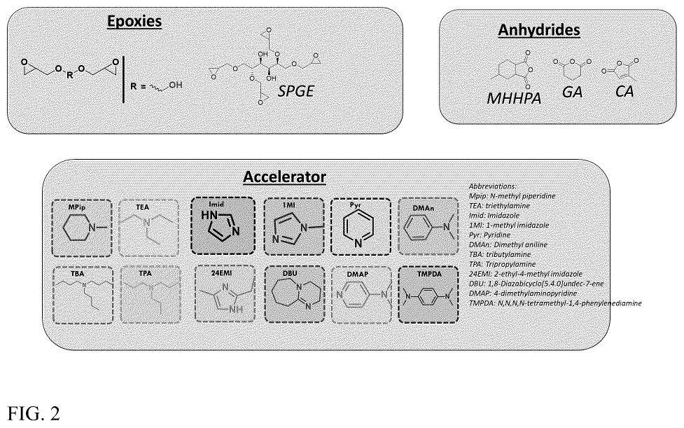

FIG. 2 depicts representative structures and example monomers are given above for each class of materials. Monomers are combined in any addition order and in varying stoichiometry (anhydride to epoxide). Monomers (generally liquid but can be solid) are mechanically mixed with and/or without solvent to generate a homogenous mixture of monomers. The mixture can then be cast into desired shape or into desired reinforcing media (carbon fiber, glass fiber, basalt fiber, Kevlar, flax fibers, bio-fibers, fillers, etc.) where they will cure (or gel, or polymerize, or solidify) under a stimulus of time, temperature, infrared laser, or UV-light. The final solid product is then deployed or evaluated for performance. In an embodiment, methylhexahydrophthalic anhydride (MHHPA) is obtained from a Diels-Alder condensation of isoprene and maleic anhydride (obtained by biological cultivation and by conversion of fructose respectively). In an embodiment, citraconic anhydride is obtained from dehydration and subsequent decarboxylation of citric acid.

Methods disclosed herein can be used on multiple polyesters, including mixed feedstocks. The polymer concentrations used are quite high, increasing efficiency, but the required catalyst loadings are low. The process is scalable and runs at reduced energy and solvent loadings compared to most existing methanolysis systems.

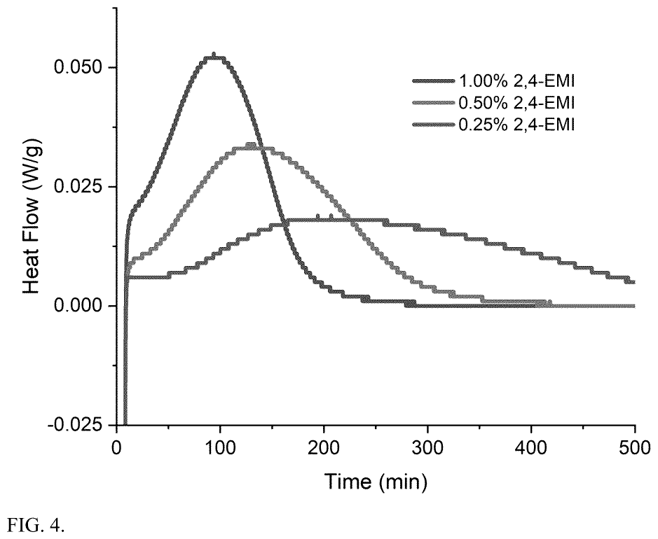

FIG. 4 depicts isothermal heat flow experiments of a PECAN formulation (specifically with 0.7 mol eq of SPGE, 0.3 mol equivalent of BDODGE, and 1.0 mol equivalent of MHHPA) with different nitrogen-based-catalyst. The heat flow of the resin sample is measured via differential scanning calorimetry (DSC) to evaluate the heat or exotherm (signal in the positive direction) of the reaction. This representative figure is an isothermal dwell of 80° C. for 500 minutes showing the effect of increasing nitrogen catalyst loading will influence the cure response.

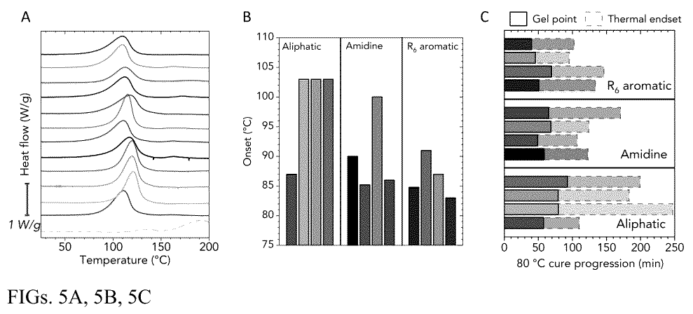

FIG. 5 depicts the effect of catalyst on the curing procedure. FIG. 5(A) depicts an overlay of DSC thermogram dynamic cures (heated from 25° C. to 200° C. at 2° C./min) analyze the heat of the reaction as a function of temperature for a variety of different nitrogen-based catalysts (0.02 mol equivalent). The thermograms are color coded to catalysts (accelerators) depicted in FIG. 2 and include, but are not limited to, N-methyl piperidine (Mpip); triethylamine (TEA); imidazole (Imid): 1-methyl imidazole (1MI): pyridine (Pyr): dimethyl aniline (DMAn): tributylamine (TBA): tripropylamine (TPA): 2-ethyl-4-methyl imidazole (24EMI): 1,8-diazabicyclo[5.4.0]undec-7-ene (DBU): 4-dimethylaminopyridine (DMAP); and N,N,N,N-tetramethyl-1,4-phenylenediamine (TMPDA).

The differences in the shapes of the exotherm show how the heat of the reaction and therefore the polymerization can be tuned with the choice in nitrogen-based catalyst. FIB. 5B depicts a graphical representation of the onset temperature, or temperature when the exotherm begins to aggressively ramp, from the dynamic curing experiments shown in (FIG. 5A). FIG. 5C depicts a graphical display of the cure progression for each PECAN system with different catalysts denoting the gel point and the cure completion at an industrially relevant temperature of 80° C. Gel point is noted as the time at which the liquid mixture become a solid quantified from rheological experiments (1% strain, 10 rad/s, 80° C.) as the point when the storage modulus and the loss modulus intersect. End set temperatures are noted as the time at which the exotherm (akin to experiments depicted in FIG. 5A) begins to rapidly decay denoted the nominal completion of the reaction.

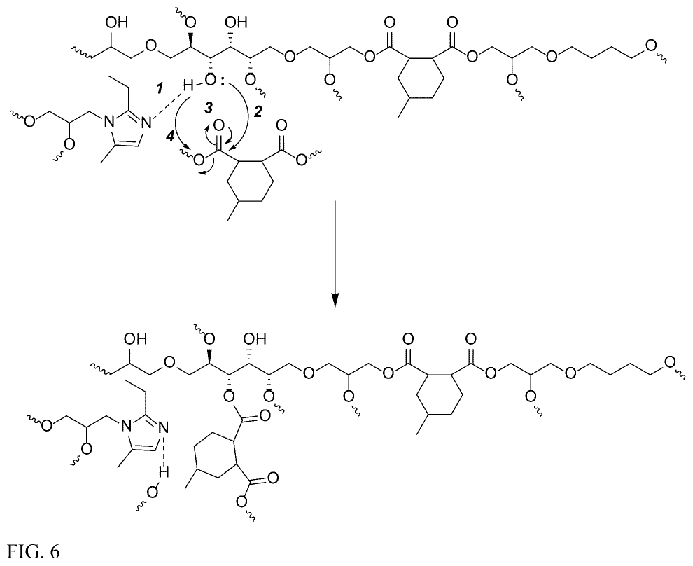

FIG. 6 depicts a proposed mechanism for the nitrogen-mediated internal reaction to the PECAN thermoset with 24EMI. (1) The lone pair of the nitrogen will coordinate to the proton of a sorbitol backbone hydroxide, increasing the electron density of the oxygen. (2) The same oxygen will then bond to the carbon center of the ester, generating a tetrahedral intermediate (not shown) as the electrons from one of the double bonds of the ester shift to the oxygen. (3) Electrons then displace back into the ester double bond while simultaneously displacing the oxygen. (4) At the time of displacement, the oxygen will bond to the coordinated hydrogen completing the reaction (transesterification).

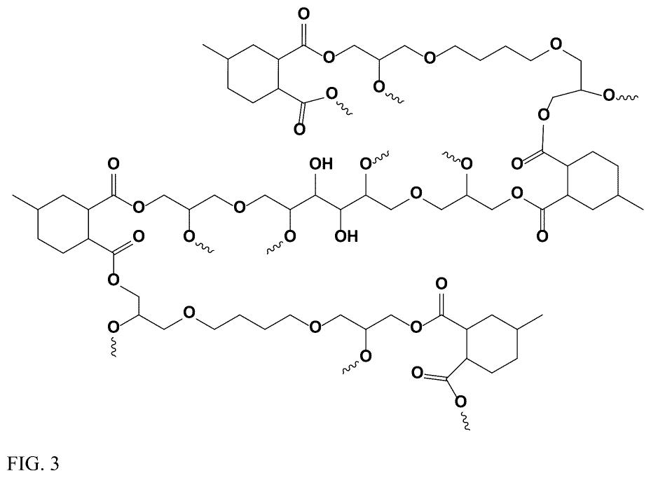

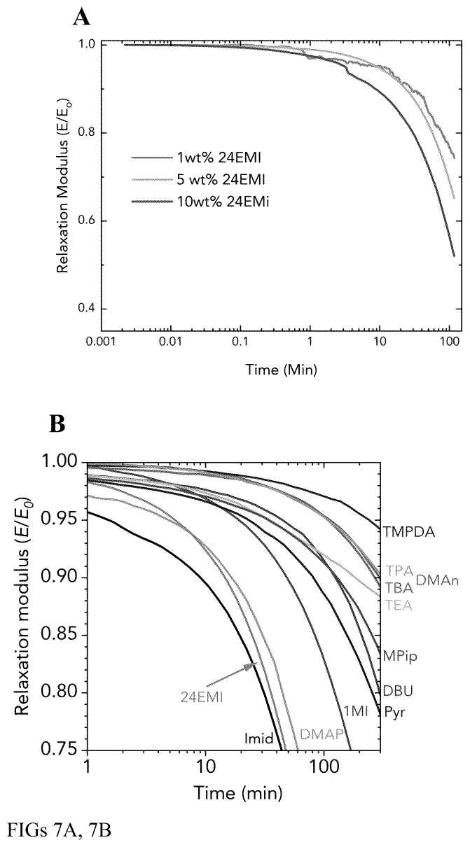

FIGS. 7A and 7B depict stress relaxation experiments. FIG. 7A depicts a PECAN formulation with different concentrations of 24EMI at 200° C. within a Dynamic Mechanical Analyzer (DMA). A stress relaxation experiment will apply a deformation to a sample (1% strain in this case) and monitor the force (converted to modulus) as a function of time. For dynamic networks (such as the PECAN performing transesterification (FIG. 3)), the force will decrease over time resulting in a decrease in the modulus (relaxation modulus in this case) that is then normalized (E/E₀). FIG. 5B depicts similar relaxation experiments (0.25% strain, 200° C.) that were performed for PECAN thermosets cured with alternative catalysts (0.02 mol equivalent) show varying relaxations, dependent on the amine catalyst.

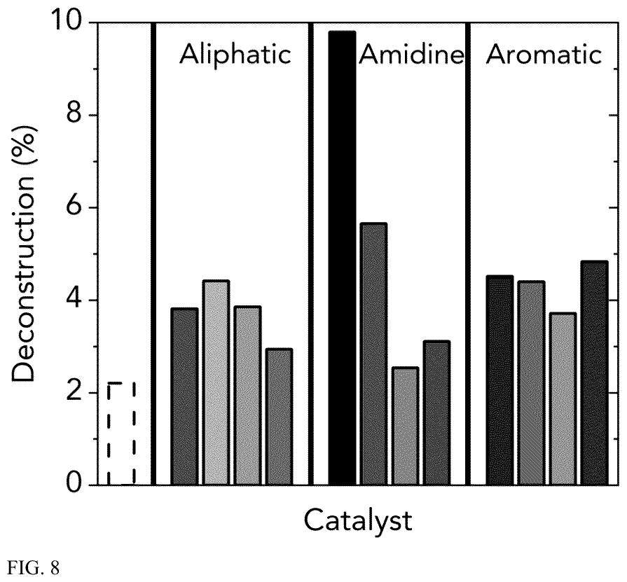

FIG. 8 depicts a comparison to the external transesterification efficacy of PECAN polymers cured with alternative nitrogen-based catalysts and PECAN polymer cured without any catalyst. The percent destruction of the polymers are color coded to catalysts (accelerators) depicted in FIG. 2 including, but not limited to, N-methyl piperidine (Mpip); triethylamine (TEA); imidazole (Imid): 1-methyl imidazole (1MI): pyridine (Pyr): dimethyl aniline (DMAn): tributylamine (TBA): tripropylamine (TPA): 2-ethyl-4-methyl imidazole (24EMI): 1,8-diazabicyclo[5.4.0]undec-7-ene (DBU): 4-dimethylaminopyridine (DMAP); and N,N,N,N-tetramethyl-1,4-phenylenediamine (TMPDA).

Within these experiments, resin buttons (˜0.5″ in diameter) were subjected to 5 mL methanol/g of PECAN button (˜5 mL) and heated to 130° C. for 36 hours. After 36 hours, the mass loss of the PECAN buttons were compared to the initial mass and quantified as percent deconstruction. Of note, is that all PECAN polymers exhibited higher amounts of deconstruction than that of the uncatalyzed control, validating the efficacy of the nitrogen-based catalyst in this process.

In an embodiment, another epoxy system is disclosed herein where the amine is the crosslinker (instead of the anhydride) and the epoxy houses the ester (instead of the anhydride). This system still affords a polyester 3-dimensional network that is covalent adaptable (like PECAN). Similar to PECAN, the mechanism for polymerization and transesterification is nitrogen mediated, however, the nitrogen is stoichiometric and bound to the network and not a catalyst. Additionally, due to the geometry of the highlighted section, a favorable 5-membered transition is made that can make the oxygen a better nucleophile, which can make it even faster at covalent bond exchange. As used herein, this system is Nitrogen Assisted Polyester Covalent Adaptable Network (NAPCAN).

Disclosed herein are methods to create plastics that are net-zero carbon, fully circular, and harmless to the environment. In an embodiment, disclosed herein are plastics that are derived from biobased or waste feedstocks, can be efficiently recycled without diminishing the quality, and can safely breakdown in the soil or ocean if they happen to leak into environment. In an embodiment, disclosed herein are plastics that can be designed at the molecular level to have a range of processability and recyclability in a scalable, low-energy process that minimizes the need for costly material separation and can handle a range of expected contaminates.

In an embodiment, disclosed herein are plastics with ester bonds (also commonly referred to as ester linkages). Most commodity plastics, including polyethylene and polypropylene, are comprised of molecular chains held together by strong carbon-carbon bonds, which makes these materials persistent in the environment and energy-intensive to breakdown using chemical recycling technologies. However, plastics comprised of molecular chains held together by ester linkages, can be more efficiently deconstructed into feedstock materials through known chemical recycling techniques (hydrolysis, methanolysis, enzymatic deconstruction, etc.), and because ester linkages are prevalent in naturally occurring materials, they can offer a pathway for the materials to safely breakdown in the environment.

Existing and emerging plastics with ester linkages include polyethylene terephthalate (PET), polylactic acid (PLA), polybutylene adipate terephthalate (PBAT), polycaprolactone (PCL), and polyhydroxyalkanoates (PHAs). The mechanisms used to break an ester linkage can be the same for all these materials, albeit under different conditions. Ultimately, the ease at which ester linkages in these plastics can be broken, either through a chemical process or degradation in a natural environment, depends on the molecular structure and morphology of each specific material.

In an embodiment, disclosed herein is an energy-efficient chemical processing technology that can breakdown, or deconstruct plastics with ester linkages into valuable feedstock that can be used to make the original plastics that were fed into this process (closed-loop recycling) or new plastics altogether (open-loop recycling). By enabling the deconstruction of a range of different plastics using a single processing technology, the need for excessive sortation of the materials before deconstruction is eliminated. This will also accelerate scaling of the technology because of greater available material volumes, and the technology itself will not be dependent on the commercial success of one single material.

In an embodiment, disclosed herein are methods useful for synthesizing new plastics with ester linkages.

Table 1 depicts material properties of NAPCAN, PECAN 35 and Industry Analogue polymers.

TABLE 1

| Property | | NAPCAN | PECAN 35 | Industry Analogue |
|---|---|---|---|---|
| T_{g} (DSC) | 100° C., | 85° C. | 86° C. | 115° C. |
| | 2 hrs | | | |

| | | | |
|---|---|---|---|
| T_{d5%} (TGA) | 286° C. | 299° C. | 357° C. |
| Storage Modulus | 116° C. | 112° C. | 123° C. |
| Onset (DMA) | | | |
| Peak Loss | 119° C. | 118° C. | 118° C. |
| Modulus (DMA) | | | |
| Peak Tanδ (DMA) | 132° C. | 129° C. | 124° C. |
| Water Absorption | 0.5 | 0.5 | 0.2 |
| [ASTM D570] (%) | | | |
| Density (g/cc) | 1.19 | 1.25 | 1.13 |

Table 2 depicts a metric for industrial processing is motoring the gel point, or time at which a thermosetting resin goes from a liquid to a solid. These measurements were performed on a rheometer (1% strain, 10 rad/sec, 25 mm disposable aluminum plates, varying temperatures. At 100° C., the materials gel quite quickly, however the NAPCAN and Industry analog gel ˜2× quicker at 60° C. and below (not shown).

TABLE 2

| | NAPCAN | PECAN 35 | Industry Analogue |
|---|---|---|---|
| | Gel Time: G′ & | Gel Time: G′ & | Gel Time: G′ & |
| Temperature | G″ crossover | G″ crossover | G″ crossover |
| (° C.) | (h:min) | (h:min) | (h:min) |
| 60° C. | 01:24 | 02:30 | 01:02 |
| 80° C. | 00:25 | 00:30 | 00:15 |
| 100° C. | 00:08 | 00:06 | 00:05 |
| 120° C. | 00:03 | 00:02 | 00:02 |
| 140° C. | 00:01 | <00:01 | <00:01 |

Tables 3, 4, and 5 disclose a variety of mechanical property tests that show these materials have similar strengths, ductility, and merit comparison.

TABLE 3
compression test:

| | | | | Industry |
|---|---|---|---|---|
| Property | Methods | NAPCAN | PECAN 35 | Analogue* |
| Yield Strength | ASTM D695 | 113 | 91 | 105 |
| (MPa) | | | | |
| Modulus (MPa) | ASTM D695 | 1,523 | 1,496 | 1,089 |

TABLE 4
tensile test:

| | | | | Industry |
|---|---|---|---|---|
| | | NAPCAN | PECAN 35 | Analogue |
| Property | Methods | Type IV | Type IV | Type IV |
| Ultimate | ASTM D638 | 73 | 69 | 66 |
| Strength (MPa) | | | | |
| Modulus (MPa) | ASTM D638 | 3,505 | 2,702 | 2,112 |
| Elongation | ASTM D638 | 5 | 7 | 9 |
| at Break (%) | | | | |

TABLE 5
flexural test:

| | | | | Industry |
|---|---|---|---|---|
| Property | Methods | NAPCAN | PECAN 35 | Analogue |
| Flexural Strength | ASTM D790 | 104 | 97 | 92 |
| (MPa) | | | | |
| Tangent Modulus | ASTM D790 | 2,742 | 2,518 | 2,840 |
| (MPa) | | | | |
| Flexural Strength | ASTM D790 | 4 | 7 | 8 |
| at Yield (%) | | | | |
| Flexural Strength | ASTM D790 | 6 | 12 | 11 |
| at Break (%) | | | | |

The foregoing disclosure has been set forth merely to illustrate the invention and is not intended to be limiting.

We claim:

1. A method for making thermosetting resin systems comprising a nitrogen assisted polyester covalent adaptable network wherein the method comprises use of at least a di-glycidyl ester with at least a di-amines wherein the network is capable of transesterification at increased rates over epoxy-anhydride systems.

2. The method of claim 1 further comprising a step of adding an accelerator.

3. The method of claim 2 wherein the accelerator comprises 2-ethyl-4-methyl imidazole.

4. The method of claim 2 wherein the accelerator comprises N-methyl piperidine triethylamine, imidazole, 1-methyl imidazole, pyridine, dimethyl aniline, tributylamine, tripropylamine, 2-ethyl-4-methyl imidazole, 1,8-diazabicyclo[5.4.0]undec-7-ene, 4-dimethylaminopyridine, and N,N,N,N-tetramethyl-1,4-phenylenediamine.

5. The method of claim 2 wherein the network can rearrange with itself to allow re-processing and with methanol to allow depolymerization.

6. The method of claim 3 wherein the reactions are catalyzed and/or accelerated by a nitrogen-based unit.

7. The method of claim 4 comprising the use of different nitrogen-based accelerators at different loadings to accelerate both cure and transesterification.

8. A composition of matter comprising a polymer made using NAPCAN that comprises ester linkages in an epoxy and reacts with amines.
